(19) United States
(12) Patent Application Publication
(10) Pub. No.: US 2016/0271997 A1
(43) Pub. Date: Sep. 22, 2016

(54) ROLLABLE, SELF-ADHESIVE DRY ERASE SHEET ASSEMBLY AND METHOD OF USE

(71) Applicant: 3M INNOVATIVE PROPERTIES COMPANY, Saint Paul, MN (US)

(72) Inventors: Tracie J. Berniard, St. Paul, MN (US); Mitchell A. F. Johnson, Maplewood, MN (US); Elizabeth A. Brodd, St. Paul, MN (US)

(21) Appl. No.: 15/033,354

(22) PCT Filed: Oct. 30, 2014
(86) PCT No.: PCT/US2014/063098

§ 371 Date: Apr. 29, 2016

Related U.S. Application Data
(60) Provisional application No. 61/897,754, filed on Oct. 30, 2013.
(60) Provisional application No. 61/921,885, filed on Dec. 30, 2013.

(51) Int. Cl. B43L 1/12

(52) U.S. Cl. CPC B43L 1/123

(57) ABSTRACT

A dry erase sheet assembly comprising: (a) a writing member having a front major surface and a rear major surface wherein the front major surface is capable of being used as a dry erase surface; (b) a support member having a low Deflection Stiffness Rating; (c) a pressure sensitive adhesive disposed on the rear major surface of the support member; and (d) a removable liner on the rear surface of the adhesive; wherein the sheet assembly is capable of being wound upon itself into roll configuration without disruption and the sheet assembly has a low Curl Memory Rating. Also a method of using such sheet assemblies.

### FIELD

This invention relates to self-adhesive dry erase articles, in particular to dry erase sheet assemblies that can be wound into roll form without disruption and yield dry erase sheets that can be adhered to a support such a wall and used as a dry erase surface. In some instances, the dry erase sheets can be removed from the support without damage to the support.

### BACKGROUND

Dry erase boards have been used as writing surfaces for years because of their convenience and versatility. The boards provide convenient means for expression while eliminating the mess and trouble of a chalk board.

Conventionally, dry erase boards, sometimes referred to as white boards, were rigid. Flexible versions are now known, used in mobile and other instances where rigid conventional boards are not as well suited. For instance, US Patent Appln. Publn. Nos. 2010/005561 (Hegwood) and 2012/0183943 (Budryk et al.) disclose portable devices that provide a retractable writing surface.

In addition, certain commercial products are sold in adhesive-backed roll form to be applied to support surfaces such as walls to provide writable surfaces. Roll form is a convenient configuration in which to store and transport sheet articles such as self-adhesive dry erase assemblies comprising a member having dry erasable writing surface, pressure sensitive adhesive layer, and removable liner. Sheet products wound into roll configuration can be more easily packaged in protective manner (e.g., in a protective box or tube) and the resultant packages are typically less awkwardly shaped thereby facilitating storage, transport, handling, and distribution.

To maximize such potential convenience of roll configuration, it is desired to wind adhesive-backed dry erase sheet assemblies s into relatively tight roll configuration (i.e., having small internal diameters, e.g., about 4 inches, preferably smaller). However, winding a multilayer assembly into roll configuration imposes a complex combination of stresses upon the assembly and its constituent member (e.g., relatively tensile stresses more distantly from the axis of winding coupled with relatively relatively compressive stresses more proximately to the axis of winding). As a result, winding assemblies comprising adhesive-backed sheets with liners into roll configuration often results in disruption within the assembly as it is rolled, particularly if it is wound into a relatively tight roll configuration. Such disruptions may include interlayer separations (e.g., liner from adhesive or adhesive from other components of dry erase sheet) or intralayer damage (e.g., buckling or wrinkling within the adhesive layer or writing member) of the dry erase sheet. The detrimental impact of such disruptions may range from imparting an aesthetically undesirable appearance to the product to formation of physical artifacts in one or more layers of the dry erase sheet that impair its functionality.

To lessen the disruption encountered by winding dry erase sheet assemblies into roll configuration, vinyl and similar materials are commonly used in the dry erase sheet construction. Such dry erase sheets, however, do not provide desired performance Such dry erase sheets typically fail to provide a sufficiently flat, smooth writing surface as is desired because roughness and irregularities in the underlying surface to which they are adhered is transposed to the writing surface. In addition, such materials are subject to damage arising from disruptions that may occur during winding into and unwinding from roll configuration (e.g., an initially smooth layer may adopt wrinkles and other discontinuities due to the various interlayer and intralayer disruptions), such damage leading to artifacts that impair the quality of the resultant writing surface.

Another problem with some commercial adhesive-backed dry erase sheets is that they may not adhere effectively to the desired surfaces (e.g., a wall or door), tending to separate from or even fall off. In some cases, adhesive-back dry erase sheets are intended for temporary use, with adhesives intended to permit removal of the dry erase article from the support surface, results in damage to the surface because the adhesive developed an unintentionally strong bond to the surface.

The need exists for improved self-adherent dry erase articles that can be wound into roll form (e.g., for storage, shipping, etc.), maintain an aesthetically and functionally acceptable appearance despite having been wound into roll form, then unwound and bonded to a support surface to provide a writable surface thereon that is a smooth and pleasing writable surface. In addition, the need exists for self-adherent dry erase articles that can be removed as desired from a support while remaining suitable for reuse and without damage to the underlying support.

### SUMMARY

The present invention provides novel self-adhesive dry erase sheet assemblies that can be used to form dry erasable writing surfaces on desired supports (e.g., walls, door panels, etc.). The sheet assemblies of the invention provide surprising heretofore unattained performance. The sheet assemblies of the invention are capable of being wound into roll form and then unrolled without disruption and upon removal of the liner can be adhered to a desired support to form smooth and pleasing writable surfaces. The invention also provides methods for using such sheet assemblies.

In brief summary, a rollable dry erase sheet of the invention typically comprises:
(a) a writing member having a front major surface and a rear major surface, the front major surface is capable of being used as a dry erase surface;
(b) a support member having a front major surface and a rear major surface, the support member having a Deflection Stiffness Rating (defined below) of about 0.75 inch (1.9 centimeters) or less, wherein the writing member is disposed on the front major surface of the support member;
(c) a pressure sensitive adhesive disposed on the rear major surface of the support member; and
(d) a removable liner on the rear surface of the adhesive;
   wherein the sheet assembly is capable of being wound upon itself into roll configuration, e.g., having an internal diameter of about 4 inches (10.2 centimeters) or less, substantially without disruption and the sheet assembly has Curl Memory Rating (defined below) of about 2.0 inches (5.1 centimeters) or less. Typically, sheets of the invention will be stored and transported while wound into roll form though sheets may be stored and transported in flat form if desired. As used herein, “without disruption” means that when wound into roll configuration, the sheet assembly does not under undergo interlayer separations (e.g., liner from adhesive or adhesive from other components of dry erase sheet) or intralayer damage (e.g., buckling or wrinkling within the adhesive layer or writing member) of the dry erase sheet.

Briefly summarizing, the method of the invention typically comprises:
(a) providing a dry erase sheet assembly of the invention (e.g., wound into roll form or in flat form);
(b) unrolling the sheet assembly if it is in roll form; and
(c) removing the removable liner thereby yielding the dry erase sheet and exposing the rear surface of the adhesive; then
(d) bonding the dry erase sheet to a desired support surface; and
(e) using the sheet as a dry erase surface (e.g., writing and erasing).
   In select embodiments, the dry erase sheet can be removed from the support surface substantially without damaging the support surface.

Dry erase sheet assemblies and the method of the invention can provide several advantages. When wound into roll form, whereas conventional dry erase sheets and sheet assemblies are subject to buckling of component members or other disruption (e.g., formation of creases in the resultant writing surface), or even if permanent dimensional distortion is not caused, many consumers will perceive rolled sheets with buckled portions as being unsatisfactory. When applied to a support, the resultant writing surface is smooth and uninterrupted, providing a pleasing writing experience and easy erasure. Use of relatively stiff support members in accordance with the invention permits use of relatively strong adhesives that provide sufficient adhesion to the support surface (e.g., painted wall, desk top, etc.), to support the dry erase sheet stably during use for convenient writing, while reducing the potential for damage to the supporting surface when the dry erase sheet is removed.

### BRIEF DESCRIPTION OF DRAWING

The invention is further explained with reference to the drawing wherein:

FIG. 1 is a cross sectional view of a portion of an illustrative embodiment of a dry erase sheet assembly of the invention;

FIG. 2 is schematic view of a portion of an illustrative embodiment of a dry erase sheet assembly of the invention wound into roll configuration;

FIG. 3 is cross sectional view of a dry erase sheet of the invention adhered to a support;

FIG. 4 is a schematic diagram of carrying out measurement of the Deflection Stiffness Rating of a film; and

FIG. 5 is a schematic diagram of carrying out measurement of the Curl Memory Rating of a sheet assembly.

These figures are not to scale and are intended to be merely illustrative and not limiting.

### Key and Glossary

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g., 1 to 5 includes 1, 1.5, 2, 2.75, 3, 3.80, 4, and 5). As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

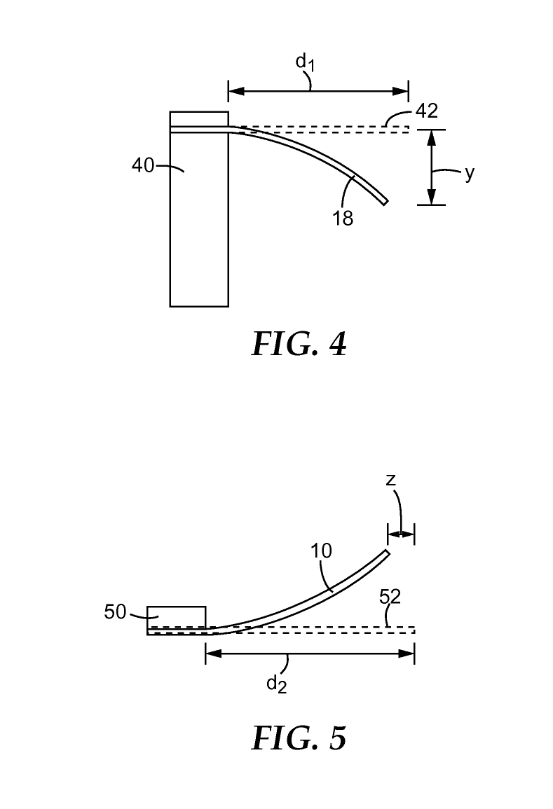

The term “Deflection Stiffness Rating” as used here describes the stiffness of the support member and is measured as the distance that the end of a self supported 1.0 inch wide by 4.0 inch long (2.5 by 10.2 centimeters) portion of the support member material deflects from horizontal under gravity at a temperature of 70° F. (21° C.). FIG. 4 is a schematic diagram of carrying out measurement of the Deflection Stiffness Rating of a film.

The term “Curl Memory Rating” as used here describes the residual curl tendency of the sheet assembly and is measured as the horizontal distance that the edge of a 5 inch (12.7 centimeters) long portion of a sheet assembly (oriented in parallel to the dimension in which the sheet assembly was wound about itself into roll configuration), after the sheet assembly has been configured in roll form of a cylinder having a 2 inch (5.1 centimeters) inside diameter at 70° F. (21° C.) for at least 24 hours, and then unrolled and laid flat on a horizontal surface, exterior face down, curls back. FIG. 5 is a schematic diagram of carrying out measurement of the Curl Memory Rating of a sheet assembly.

### DETAILED DESCRIPTION OF ILLUSTRATIVE EMBODIMENTS

In brief summary, a rollable dry erase sheet of the invention typically comprises:
(a) a writing member having a front major surface and a rear major surface, the front major surface is capable of being used as a dry erase surface;
(b) a support member having a front major surface and a rear major surface, the support member having a Deflection Stiffness Rating (defined below) of about 0.75 inch (1.9 centimeters) or less, wherein the writing member is disposed on the front major surface of the support member;
(c) a pressure sensitive adhesive disposed on the rear major surface of the support member; and
(d) a removable liner on the rear surface of the adhesive;
   wherein the sheet assembly is capable of being wound upon itself into roll configuration having an internal diameter of about 4 inches (10.2 centimeters) or less without disruption and the sheet assembly has Curl Memory Rating (defined below) of about 2 inches (5.1 centimeters) or less.

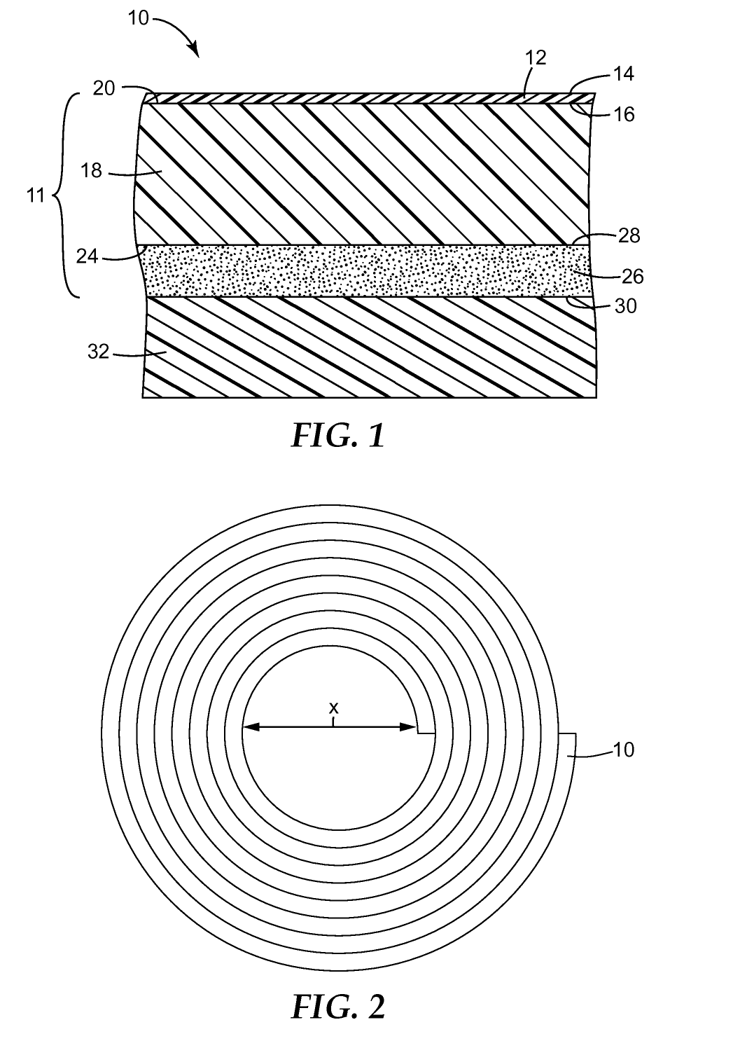

FIG. 1 shows in cross sectional view a portion of an illustrative dry erase sheet assembly 10 of the invention comprising: (a) a writing member 12 having a front major surface 14 and a rear major surface 16 wherein the front major surface is capable of being used as a dry erase surface; (b) a support member 18 having a front major surface 20 and a rear major surface 24; (c) adhesive 26 the front surface 28 of which is adhered to rear major surface 24; and (d) a removable liner 32 on the rear surface 30 of the adhesive. Dry erase sheet 11 comprises writing member 12, support member 18, and adhesive 26, the rear surface 30 of which can be used to adhere dry erase sheet 11 to a support (not shown) as desired.

FIG. 2 shows a portion of an illustrative dry erase sheet assembly 10 of the invention wound into roll configuration. As desired, the dry erase sheet assembly may be wound into roll configuration with the liner side facing in to the center of the resultant roll or cylinder or, alternatively, with the liner side facing outward and writing surface facing in to the center of the resultant roll or cylinder. An advantage of the present invention is the dry erase sheet assembly can be wound into roll form without undergoing the disruption typical of conventional dry erase sheeting assemblies. Dry erase sheet assemblies of the invention can be wound into relatively tightly (e.g., to an internal diameter of 4 inches or less (i.e., indicated by dimension x in FIG. 2)). Dry erase sheet assemblies of the invention can be wound into roll form without an optional core (as shown in FIG. 2) or with an optional core (not shown) as desired.

Writing Member

Writing member 12 has a front major surface 14 which is capable of being used as a dry erasable writing surface. Suitable materials can be readily selected by those skilled in the art.

Acceptance of ink on writing member 12 as written indicia without beading of the ink can be defined as the “wettability” of the dry erase writing surface. Wettability refers to a writing line that can retain its applied shape as the solvent dries. Dewetting of the solvent causes the line to move in or break at certain points, causing voids in the writing. Acceptable wettability (or writing without dewetting) is accomplished if the surface energy of the writing surface is greater than the surface tension of the solvents in the marker inks. Written indicia is preferably received as a continuous layer, preventing beading up or “gaps” in the lines forming written indicia.

The writing surface additionally provides a level of “erasability” which allows the user to wipe away (e.g. with a dry cloth or dry eraser) indicia written with a dry erase marker once it is no longer desired. Acceptable erasability is achieved if the surface energy of the writing surface is sufficiently low to prevent tenacious adhesion of the binders and other solids in the marker inks to the writing surface. Solvent compositions of dry erase markers are typically listed on the marker or reported on the MSDS for the marker. Common solvents for dry erase markers include, for example, ethanol, isopropanol, methyl isobutyl ketone and n-butyl acetate. One solvent with a high surface tension is n-butyl acetate, having a surface tension of about 25 mJ/m². Therefore, in some embodiments, a dry ease surface can be wettable by solvents with a surface tension of about 25 mJ/m² or less. In one embodiment, the surface energy of the writing surface is within the range of about 25 mJ/m² to about 40 mJ/m². In another embodiment, the surface energy of the writing surface is within the range of about 30 mJ/m² to about 35 mJ/m², as measured by the Dyne Pen Test.

Additionally, written indicia can preferably be quickly removed from dry erase article with a minimum of wiping and a minimum of absorbance of ink (or “ghosting”) by dry erase article. Acceptable removability of the ink is achieved if the surface energy of the writing surface is sufficiently low to prevent the binders and other solids in the marker inks from adhering tenaciously to the writing surface. Therefore, in one embodiment, the writing surface of the dry erase article has a surface energy less than or equal to about 40 mJ/m². In an alternate embodiment, the writing surface of the dry erase article has a surface energy less than or equal to about 35 mJ/m².

An advantage of the present invention is that resultant writing surfaces made in accordance with the invention are substantially flat without bumps or other surface irregularities (whether imparted from conformance to an unduly rough support surface or creases and other disruptions formed from rolling and unrolling the sheet). As a result, writing surfaces of the invention provide pleasing, smooth writing action. In addition, writing surfaces of the invention can be easily erased as there are no ridges, valleys, etc. to disrupt erasing action.

Illustrative examples of suitable materials for use as writing members of sheets and sheet assemblies of the invention are sheets and films of polymeric resins, including both thermoplastic and thermoset resins that are coated with a radiation curable hardcoat. Example polymeric resins suitable for use include polyesters, polyethers, polyamides, polyurethanes, polyacrylates, polyethylene, polypropylene, polyvinyls, cellulose esters, epoxy resins, phenolic resins, and the like. Illustrative examples of commercially available flexible dry erase surfaces are made with ultraviolet radiation (UV) curable hardcoat films. Exemplary polyester films with a UV curable hardcoat are available from Protect-all, Inc., Darien, Wis. As desired the underlying film and/or overlying hardcoat may be colored, the overcoat may be substantially transparent, the film may have an image pattern formed thereon prior to application of the hardcoat, etc.

In some embodiments, writing member 12 typically has a thickness of from about 1 to about 5 microns or more, though those having dimensions outside this range may be used if desired.

The front surface of the writing member may be substantially smooth or slightly roughened as desired. As is known to those skilled in the art of dry erasable surfaces, slight texturing or roughening of the surface, e.g., such as be embossing or other suitable means, may be used to achieve reductions in glare and optimize writability and erasability performance. For example, in some embodiments, the front surface of the writing member of articles of the invention will have an average surface roughness Ra ranging from about 60 to about 1000 microinches (1.5 to 25.4 microns), as measured by a contacting stylus profilometer.

The writing member of sheets and sheet assemblies of the invention is typically relatively thin as compared to the underlying support member. Typically the writing member will be less than about 10 microns thick, in some instances less than about 7 microns thick, and in some instances between about 2 and about 5 microns thick.

Those skilled in the art will be able to readily select suitable writing members. Illustrative examples of materials suitable for use as the writing member of dry erase sheets and sheet assemblies of the invention are disclosed in US Patent Appln. Publn. Nos. 2004/0081844 and 2006/0024463; U.S. Pat. Nos. 4,885,332, 5,104,929, 6,458,462, and 6, 265, 611; and PCT Publn. No. WO2011/094342, each of which is incorporated herein by reference in its entirety.

Support Member

Support members of dry erase sheets of the invention typically have a Deflection Stiffness Rating equal to about 0.75 inch (1.9 centimeters) or less, preferably equal to about 0.5 inch (1.3 centimeters) or less. FIG. 4 is a schematic diagram of carrying out measurement of the Deflection Stiffness Rating of a support member 18. A piece of support member material is mounted in a clamp 40 with an unsupported 1 inch (2.5 centimeter) wide by 4 inch (10.2 centimeter) long portion of the support member material extending beyond the clamped portion and allowed to deflect under gravity at a temperature of 70° F. (21° C.). The Deflection Stiffness Rating of support member 18 is measured as the vertical distance y that the end of material 18 deflects from the horizontal plane 42, with a relatively stiffer material exhibiting a lower Deflection Stiffness Rating.

To exhibit the desired Deflection Stiffness Rating, the support member is preferably selected for suitable flexural rigidity which is dependent in part upon the Young's Modulus and thickness of the member selected.

Young's modulus (or elastic modulus) is the slope of the stress vs. strain curve in the region where deformations are small. In this region, when the sheet is deformed by a force, the sheet will recover its original shape when the force is removed.

The stiffness of the support member depends on the Young's modulus of the material it is made from as well as its shape. In the case of support members of dry erase sheet assemblies of the invention, its stiffness can be readily expressed in the form of flexural rigidity (D) of a plate according to the following formula:

$$D = \frac{{Eh}^{3}}{12 ( 1 - {v}^{2} )}$$

wherein E is Young's modulus, h is the sheet thickness, and v is the Poisson's ratio of the sheet material. As sheet thickness increases, so does its flexural rigidity. The relative stiffness of the support member can be increased by increasing its thickness, though at the burden of increased cost, increased, weight, etc. Polymeric materials that offer good combination of desired stiffness and flexural rigidity at useful thicknesses include polyester (e.g., E equals about 2 to about 2.7 GPa), polycarbonate (e.g., E equals about 2.4 to about 3.4 GPa), polystyrene (e.g., E equals about GPa 3 to about 3.4), polymethyl methacrylate (e.g., E equals about 2.4 to about 3.4 GPa), and combinations thereof. Typically polymeric materials having a Young's Modulus in the range from about 2 to about 4 GPa will provide a combination of effective flexural rigidity at useful thickness for use as support members in sheets and sheet assemblies of the invention. In contrast, such polymeric materials as polyethylene, polypropylene, and polyvinyl chloride, which are commonly used in self-adhesive dry erase sheets and sheet assemblies, are insufficiently stiff for use in the present invention.

If desired, the support member may comprise or even consist essentially of metal films. An advantage of such support members is that they can permit use of relatively thinner support members, thus reducing some of the complex tensile/compressive stresses the sheet assembly undergoes when being wound into roll configuration. For instance, the Young's Modulus of steel is approximately 200 GPa, and steel films having thicknesses in the range of from about 2 to about 4 mils (50 to 100 microns) can be used in sheet assemblies of the invention. In some embodiments, high carbon steel is preferred as it can provide improved roll toughness (i.e., withstand greater rolling stresses than lower carbon steels without developing curl memory).

Sufficient flexural rigidity of the support member and in turn of the dry erase sheet of which it is a component will prevent it from deforming under the force of writing serving so as to mask irregularities in the surface of the support (e.g., wall) on which the sheet is adhered. A rigid sheet will provide a smooth writing surface even on a rough wall. The present invention provides dry erase sheet that can be wound into roll configuration without disruption and yet still provide a desirable writing surface on even surfaces having significant roughness and irregularities (e.g., unfinished dry wall, poorly seemed dry wall, cement, etc.).

The flexural rigidity of the sheet will prevent it from deforming under the force of hand lamination of the full construction to a textured wall. Significant force is required to deflect a rigid sheet to conform to the wall texture. Once the force of hand lamination is removed, the sheet will return to its original shape depending on the strength of the adhesive and contact area with the wall texture.

The support member serves to support the writing member during assembly of the sheet and subsequent rolling, storage, shipment, unrolling, and installation thereof. In addition to supporting the writing member, the support member serves to mask irregularities in the underlying support to which the sheet is to be applied (e.g., a wall, door panel, etc). For instance, the support to which the sheet is applied may have a relatively rough surface (e.g., wood grain, cinder block, etc.). If the sheet conforms closely to the contours of such a surface so as to impart such contour to the writing member, the sheet of the invention may delaminate and/or the resultant writing surface may be rougher and less pleasing than desired. Thus, the support member serves in part to insulate the writing member from a tendency to stretch or conform as the sheet is applied to a supporting surface. In addition, we have found that the support member preferably exhibits sufficient stiffness and dimensional stability that the degree to which the adhesive wets out the surface of the wall is reduced. An illustrative preferred support member is polyester film from about 5 to about 10 mils (127 to 254 microns) thick. We have found that self-adhesive dry erase sheets made with such support members can be readily unrolled and adhered to a wall, using adhesive which provides secure bond to the wall, yet still removed from the wall without damage thereto. In comparison, otherwise similar dry erase sheets made with vinyl support members are more likely to result in damage to the wall when removed as well as yield writing surfaces which are less smooth, conforming more closely to the contours of the supporting wall. Such conformance results in roughness to the writing surface which may tend to reduce visibility or contrast of the writing on dry erase sheet.

Support members having thinner thickness may be used but will often be too readily damaged during fabrication and use of sheets of the invention. Such support members may tend to conform to the contour of the support surface such that the resultant writing surface is not of desired quality. Support members having greater thickness will tend to increase costs, may be more difficult to roll up, and render the resultant sheet heavier than desired.

Depending upon the materials selected, the support member may need to be primed or a surface treatment applied thereto to attain desired adhesion to the overlying writing member and underlying adhesive.

A rigid support member as described herein also facilitates removal without damaging the wall. Thus, surprisingly, use of the relatively rigid support member allows use of a relatively stronger adhesive on the dry erase article which increases the duration of useful life of the construction while facilitating removal.

Illustrative examples of materials from which support members of sheets and sheet assemblies of the invention can be made include polymer films and metal films (including, e.g., homogeneous films, composite films, filled composite films, etc., and combinations thereof). Support members may be of monolayer or multilayer construction.

Referring to FIG. 1, as will be understood, the support member may be primed on its front surface 20 to provide desired adhesion to the writing member 12, and primed on its rear surface 24 to provide desired adhesion to the adhesive 26.

The support member may contains ferromagnetic materials (e.g., steel support member or magnetic filler in a composite support member) to make the resultant dry erase sheet useful with magnetics.

Adhesive

The adhesive is disposed on the rear major surface of the support member.

The adhesive serves to bond the dry erase sheet to a selected support surface (e.g., a wall, door, etc.). Such bond may be permanent or temporary as desired. The adhesive will often be in the range of from about 0.5 to about 2 mils (1.3 to 5.1 centimeters) thick, though it will be understood that adhesive coatings with thickness outside this range may be used if desired. If the adhesive is too thin, the sheet may be more likely to fail to achieve desired strength of adhesion to the support. If the adhesive is too thick, the sheet and sheet assembly will be heavier, and the resultant thickness of the sheet assembly may make it more difficult to wind into roll configuration.

Those skilled in the art can readily select suitable adhesive for use herein. Typically, the adhesive is pressure-sensitive. It preferably provides an initial adhesion to painted dry wall (i.e., Sherwin Williams ProMar® 200, Zero VOC Interior Latex Paint applied with standard paint roller, ⅜ inch (0.95 centimeter) nap) of from about 80 to about 320 g/inch-width (31 to 126 g/centimeter-width). Adhesives which provide higher adhesion will tend to damage the wall when the dry erase article is moved therefrom. Adhesives which provide lower adhesion may tend to fail, resulting in undesired separation of the dry erase article from the wall. In addition, initial adhesion to drywall is also important to facilitate liner removal as the sheet is adhered to the desired location on the support (e.g., wall, door, room partition, etc.).

Those skilled in the art will be able to readily select suitable adhesive for use in desired applications. Illustrative examples of suitable adhesives suitable for removable applications are disclosed in U.S. Pat. No. 5,824,748 which is incorporated herein by reference in its entirety.

To install a dry erase sheet on a support such as a wall, typically a small section of liner is peeled from the sheet and the exposed portion of adhesive is then laminated to the wall. The remainder of the liner is then removed and remaining portion of adhesive adhered to the wall. A minimum initial adhesion to painted drywall is required to facilitate this method of installation.

Liner

The removable liner covers the adhesive on the rear major surface of the support member. Preferably the liner is such that (1) the composite sheet may be wound into roll form without disruption (i.e., buckling or warping of the writing surface, etc.), and (2) the liner can be readily removed by hand such that a consumer can readily do so.

A problem with many conventional rolled dry erase films is the tendency of the construction to buckle when in rolled form. Even if such buckling does not impair the product by forming wrinkles or creased therein, it is a significant cosmetic defect that is off putting to many consumers.

We have found that in order to be able to provide dry erase sheet assemblies capable of being rolled up readily (that is sufficiently flexible) while also capable of yielding dry erase sheets that provide pleasing (i.e., substantially flat) writing surfaces when mounted on a relatively rough support (that is of lesser conformability than is typical of rolled dry erase films), that the liners should be relatively compliant as compared to the support member.

In some embodiments, the release liner will have a tensile elongation of about 500% or more. Accordingly, many commonly known liner materials such as paper-based liners and polypropylene liners are not suitable for use herein.

In addition, typically it is preferred that in addition to exhibiting high tensile elongation, the liner is preferably easy to deform. The liner should preferably have a low elastic modulus so that the liner can deform under small stresses encountered in rolling/packaging.

In addition to selecting a liner material that inherently has a low elastic modulus, the modulus of the liner material can be reduced by embossing it.

LDPE has a typical bulk modulus of about 300 MPa. If we emboss a 75 micron thick sheet we can reduce the modulus to about 116 MPa. We can further reduce the elastic modulus to about 75 MPa if we emboss a 125 micron sheet.

A thicker liner also improves ability to remove the liner from the adhesive coated sheet. An embossed 125 micron liner is preferred in some instances because the liner removal force is significantly below the initial adhesion of a thicker 175 micron PET film with adhesive to painted drywall. Thus, the optimal thickness of a given liner material is dependent in part upon its adhesion properties to the adhesive formulated for desired resultant adhesion to the support to which the dry erase sheet is adhered. In many instances, the liner is selected to provide a 90° peel force (i.e., measured at a peel rate of 12 inches/minute (30.5 centimeters/inch), having applied the sheet by placing it, adhesive-side down, on the support and running two passes of a handheld 5 lb. (2.3 kilogram) roller) from the adhesive of from about 50 g/inch-width to about 150 g/inch-width (20 to 60 grams/centimeter-width).

For instance, it has been observed that in one embodiment of the invention that a dry erase sheet having a polyethylene liner could be wound into a roll with a radius as small as about 0.5 inch (1.3 centimeter) then unrolled for use to provide a smooth, pleasing dry erase surface while a similar dry erase sheet made using a polypropylene liner instead resulted in buckling when rolled to a radius of about 5 inches (12.7 centimeters) or smaller.

It has also been observed, the liners which do exhibit sufficient strength of adhesion to the adhesive will undergo buckling even if the liner has a relatively high tensile elongation value.

Illustrative examples of materials suitable as use for removable liners herein include polyethylene films such as are available from Bloomer Plastics, Inc., etc.

Method of Use

Briefly summarizing, the method of the invention typically comprises:
(a) providing a dry erase sheet assembly of the invention (e.g., wound into roll form or in flat form);
(b) unrolling the sheet assembly if it is in roll form; and
(c) removing the removable liner thereby yielding the dry erase sheet and exposing the rear surface of the adhesive; then
(d) bonding the dry erase sheet to a desired support surface; and
(e) using the sheet as a dry erase surface, e.g., writing and erasing.
   In a typical installation, a portion of the release liner is peeled back from the assembly at one end to expose a portion of the adhesive so that it can be contacted to the support in desired position. Then the remaining portion of the liner is removed, typically at a larger peel angle, to expose the remaining portion of the adhesive and then optionally gentle wiping pressure applied to the front face of the dry erase sheet to firmly adhere it on the support.

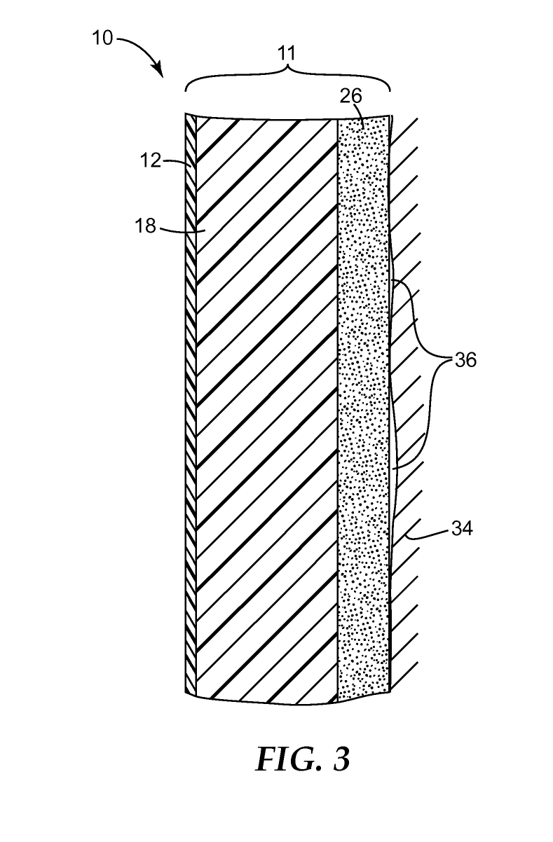

FIG. 3 shows a portion of an illustrative dry erase sheet 11 of the invention adhered to support 34. An advantage of the present invention is that support 18 provides sufficient stiffness and dimensional stability that writing member 12 remains flat despite irregularities 36 in support 34.

An advantage of dry erase sheet assemblies of the invention is that they can be wound into roll form and then unwound without having undergone undesired disruption.

Another advantage is that dry erase sheet assemblies of the invention exhibit low Curl Memory Rating. Typically, sheet assemblies of the invention exhibit a Curl Memory Rating of about 2 inches (5.1 centimeters) or less, preferably of about 1 inch (2.5 centimeters) or less. FIG. 5 is a schematic diagram of carrying out measurement of the Curl Memory Rating of a dry erase sheet assembly 10. The measurement is carried out at a system temperature of about 70° F. (21° C.). Sheet assembly 10 is mounted in a clamp 50 with a portion extending out from the clamp oriented such that the side facing in to the center of the roll configuration is facing upward. To the extent the sheet assembly exhibits curl memory, the edge will tend to curl up and toward the clamp. The Curl Memory Rating is the horizontal displacement z of the edge of sheet assembly 10 from the hypothetical position of the edge if no curling had occurred (plane 52).

In select embodiments, depending upon the adhesive selected and nature of the support, the dry erase sheet can be removed from the support surface substantially without damaging the support surface.

Configurations

Dry erase sheet assemblies may be made in any desired size and shape.

Assemblies may be cut to desired size (e.g., to form a single dry erase article of desired size, or in large rolls referred to as “jumbos”). Common sizes for such single articles range from letter or A4 size sheets to large poster size sheets. It will be understood that dry erase sheet assemblies of the invention can be made in still smaller or larger sizes as desired.

A typical conventional shape is rectangular, but it will be understood that dry erase sheet assemblies can be made in other shapes as desired (e.g., other polygons, ovals, circles, etc.).

The advantages of the invention described herein, including capability of the sheet assembly to be wound into roll form and then unwound for use without undergoing undesired disruption permit assemblies of the invention to be wound into compact roll form which greatly facilitates storage and handling.

1. A rollable dry erase sheet assembly comprising:
(a) a writing member having a front major surface and a rear major surface, the front major surface is capable of being used as a dry erase surface, the writing member having a thickness of less than about 10 microns;
(b) a support member having a front major surface and a rear major surface, the support member having a Deflection Stiffness Rating of about 0.75 inch (1.9 centimeters) or less, wherein the writing member is disposed on the front major surface of the support member;
(c) a pressure sensitive adhesive disposed on the rear major surface of the support member; and
(d) a removable liner on the rear surface of the adhesive;
wherein the sheet assembly is capable of being wound upon itself into roll configuration having an internal diameter of about 4 inches (10.2 centimeters) substantially without disruption and the sheet assembly has Curl Memory Rating of about 2.0 inches (5.1 centimeters) or less.

2. (canceled)

3. The sheet assembly of claim 1 wherein the writing member is less than about 7 microns thick.

4. The sheet assembly of claim 1 wherein the writing member is from about 2 to about 5 microns thick.

5. The sheet assembly of claim 1 wherein the support member has a Deflection Stiffness Rating of about 0.5 inch (1.3 centimeters) or less.

6. The sheet assembly of claim 1 wherein the support member is multilayer.

7. The sheet assembly of claim 1 wherein the support member comprises one or more films from the group consisting of polymer films and metal films.

8. The sheet assembly of claim 1 wherein the support member comprises a film selected from the group consisting of polyester, polycarbonate, polystyrene, polymethyl methacrylate, and combinations thereof.

9. The sheet assembly of claim 8 wherein the support member comprises polymer film and is from about 5 to about 10 mils (125 to 250 microns) thick.

10. The sheet assembly of claim 1 wherein the support member comprises polymer film having a Young's Modulus in the range of about 2 to about 4 GPa.

11. The sheet assembly of claim 1 wherein the support member comprises steel film having a thickness from about 2 to about 4 mils (50 to 100 microns).

12. The sheet assembly of claim 1 wherein the adhesive provides an initial adhesion to painted dry wall of from about 80 to about 320 g/inch-width (31 to 126 g/centimeter-width).

13. The sheet assembly of claim 1 wherein the adhesive is from about 0.5 to about 2 mils (12 to 51 microns) thick.

14. The sheet assembly of claim 1 wherein the liner comprises polyethylene film.

15. The sheet assembly of claim 1 where the sheet assembly has a Curl Memory Rating of about 1 inch (2.5 centimeters) or less.

16. The sheet assembly of claim 1 wound upon itself into roll configuration having an internal diameter of about 4 inches (10.2 centimeters) or less.

17. The sheet assembly of claim 1 wound upon itself into roll configuration having an internal diameter of about 3 inches (7.6 centimeters) or less.

18. The sheet assembly of claim 1 wound upon itself into roll configuration having an internal diameter of about 2 inches (5.1 centimeters) or less.

19. The sheet assembly of claim 1 wherein the sheet assembly is capable of being wound upon itself into roll configuration having an internal diameter of about 3 inches (7.6 centimeters) or less without disruption.

20. The sheet assembly of claim 1 wherein the sheet assembly is capable of being wound upon itself into roll configuration having an internal diameter of about 2 inches (5.1 centimeters) or less without disruption.

21. A method comprising:
(a) providing a sheet assembly of claim 16;
(b) unrolling the sheet assembly; and
(c) removing the removable liner thereby exposing the rear surface of the adhesive; then
(d) bonding the sheet to a desired support surface.

22. A method comprising:
(a) providing a sheet assembly of claim 16;
(b) unrolling the sheet assembly; and
(c) removing the removable liner thereby exposing the rear surface of the adhesive; then
(d) bonding the sheet to a desired support surface;
(e) using the sheet as a dry erase surface; and then
(f) removing the sheet from the support surface by hand substantially without damaging the support surface.
